(19) United States
(12) Patent Application Publication
(10) Pub. No.: US 2016/0103287 A1
(43) Pub. Date: Apr. 14, 2016

(54) OPTICAL FIBER CABLES WITH POLYPROPYLENE BINDER

(71) Applicant: OFS Fitel, LLC, Norcross, GA (US)

(72) Inventors: Stefan Jost, Augsburg (DK); Georg Koebler, Grossaitingen (DE); Benjamin Mohle, Augsburg (DE); Johannes Stocker, Augsburg (DE); Werner Negele, Augsburg (DE)

(21) Appl. No.: 14/512,632

(22) Filed: Oct. 13, 2014

(51) Int. Cl. G02B 6/44

(52) U.S. Cl. CPC G02B 6/441; G02B 6/4434; G02B 6/4494; G02B 6/4486

(57) ABSTRACT

An optical fiber cable includes a bundle of a plurality of loose tubes held by a polypropylene binder. The polypropylene binder sustains the heat when a hot cable sheath is applied during the cable manufacturing process. This prevents the polypropylene binder from shrinking and cutting into the loose tubes, which cause indentations. Therefore, the resulting optical fiber cable is substantially free from indentations.

### FIELD OF THE DISCLOSURE

The present invention relates generally to optical fiber cables, more specifically, to loose tube optical fiber cables.

### BACKGROUND

An optical fiber cable protects optical fibers inside of the cable using different components. For example, a loose tube optical fiber cable protects the optical fibers from an excessive tension by placing them inside of semi-rigid tubes. Such configuration allows the cable to stretch without stretching the fibers inside. One limitation of the loose tube cables is tendency to create indentations on the loose tubes by a binder. A polyester binder is a typical binder that grips a plurality of the loose tubes together. However, the polyester binder shrinks when a hot cable sheath is applied during a cable manufacturing process. At the same time, the hot cable sheath increases the temperature of the loose tubes at least partly above the glass transition temperature, which results in softening of the tubes. Thus, if the polyester binder grips the loose tubes too tight, the shrunk polyester binders cut into the loose tubes to cause indentations. Given this problem, there exists a need in the industry to manufacture loose tube optical fiber cables without any indentations.

### BRIEF SUMMARY OF THE INVENTION

Therefore, an objective of the present invention is to provide an optical fiber cable that is substantially free from indentations. One aspect of the present invention is directed to an optical fiber cable. The cable includes a cable core having a plurality of optical fibers, a polypropylene binder gripping the cable core to form a bundle, and a cable sheath surrounding the bundle.

Another aspect of the present invention is directed to a method of making an optical fiber cable. The method includes the steps of grouping a plurality of optical fibers together to form a cable core, binding the cable core with a polypropylene binder to form a bundle, and applying a cable sheath onto the bundle.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of an exemplary loose tube optical fiber cable according to one embodiment of the present invention.

FIG. 2 is a cross-sectional view of the exemplary cable of FIG. 1.

FIG. 3 is a perspective view of an exemplary bundle of loose tubes according to one embodiment of the present invention.

FIG. 4 is a perspective view of an exemplary optical fiber cable according to another embodiment of the present invention.

FIG. 5 is a perspective view of an exemplary optical fiber cable according to yet another embodiment of the present invention.

FIG. 6 is a flowchart of a method of making an optical fiber cable according to one aspect of the present invention.

### DETAILED DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

A loose tube optical fiber cable protects optical fibers from an excessive tension by placing the fibers inside semi-rigid tubes. However, during a manufacturing process, a binder that holds those semi-rigid loose tubes shrinks when a hot cable sheath is applied to the bundled loose tubes. Because the loose tubes get soften but do not change noticeably their sizes under the same condition, the binder cuts into the loose tubes and causes indentations on the loose tubes.

Indentations may increase attenuation of the resulting cable by squeezing the loose tubes and the optical fibers within the tubes, and should be avoided as much as possible. Even if there is no measurable increase in the attenuation at the time of the manufacturing, the risk still exists. For example, damages to the loose tubes done by indentations may be realized as an unexpected increase in attenuation of the cable during the cable installation or during long-term usage of the cable. If indentations are severe, the tubes may kink while handling the cable during the cable installation respectively during the cable preparation at the cable end or at the mid-span-access location. Such kinks may cause fibers inside the tubes to be damaged or to break.

However, such indentations can be successfully eliminated if the binder does not cut into the loose tubes when the hot cable sheath is applied. One way to prevent the binder to cut into the loose tubes is to use a binder that sustains the heat when the hot cable sheath is applied.

This disclosure, along with the drawings, provides a detailed description of cables that are substantially free from indentations, along with methods of making the cable.

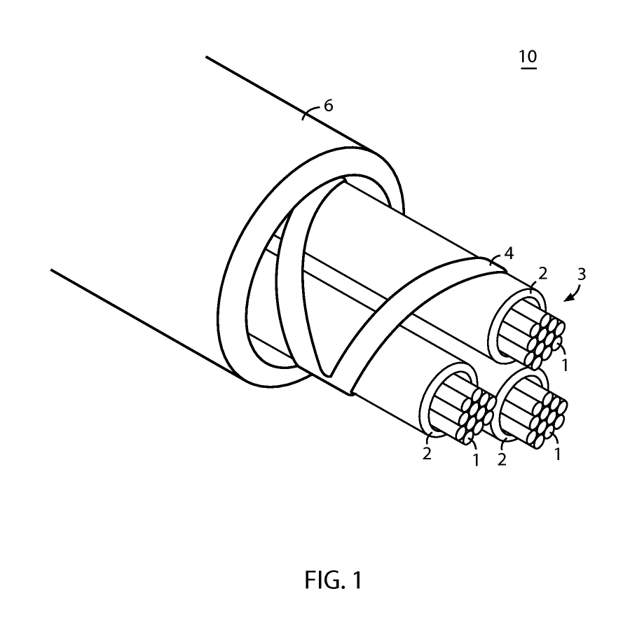

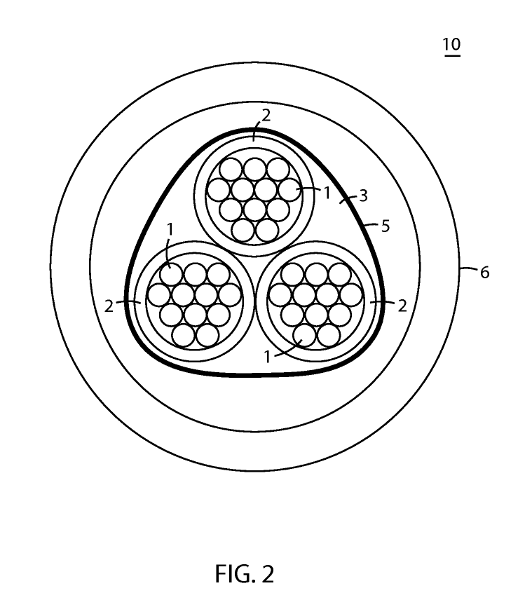

FIGS. 1 and 2 show a perspective view and a cross-sectional view of a loose tube optical fiber cable 10 according to one embodiment of the present invention. In the embodiment of FIGS. 1 and 2, the loose tube optical fiber cable 10 comprises a cable core 3, a polypropylene binder 4 that grips the cable core 3 to form a bundle 5, and a cable sheath 6 surrounding the bundle 5.

The cable core 3 includes three loose tubes 2 having twelve optical fibers 1 inside of each loose tube 2. Because the optical fibers 1 are placed inside of the semi-rigid loose tubes 2, the loose tube optical fiber cable 10 allows the cable 10 to stretch without stretching the fibers 1 inside. Such configuration protects the optical fibers 1 from an excessive tension during and after an installation. The optical fibers 1 in each loose tube 2 may be colored to aid identification of each optical fiber 1.

Because it is well known in the industry that configuration of the cable core depends on the application of the cables, only limited discussion of the cable core is provided herein. However, it should be appreciated by one having ordinary skill in the art that the cable core may include different fiber types, different number of fibers per loose tube, different number of loose tubes and other components of the cable such as a ripcord. For example, the optical fibers may be single mode or multi-mode optical fibers. Each loose tube may contain two, four, five, six, eight, twelve, twenty four or more fibers, and each loose tube may contain one or more fillers. Preferably, each loose tube contains five or more fibers and fillers in combination. Most preferably, each loose tube contains six or more fibers and fillers in combination. Furthermore, the loose tubes can be made from various materials, but is typically made from a plastic. Preferably, the loose tubes are made from polypropylene, PVC (polyvinyl chloride), PVDF (polyvinylidene fluoride) or PBT (Polybutylene terephthalate).

Referring back to FIGS. 1 and 2, the binder 4 grips the plurality of the loose tubes 2 to form the bundle 5. The binder 4 is made of polypropylene such that the binder 4 sustains the heat when the hot cable sheath is applied. More specifically, the binder 4 does not undergo thermal transition when the cable sheath is applied. The binder 4 shown in FIG. 1 is a tape that wraps around the plurality of the loose tubes 2. Preferably, the binder 4 is sufficiently wide so that the binder tension is distributed on a larger area. For example, such wide binder is preferred for a micro duct cable having a thin wall jacket such as 0.2-0.8 mm in thickness because it provides smooth and consistent outer surface of the cable, which improves the achievable distance during blowing installation into micro ducts. However, the binder 4 is not limited to the tape shape. In other embodiments, the binder 4 may be in different shape or form. For example, the binder 4 may be thread, yarn, a thin film or a tape.

The polypropylene binder has advantages over a conventional polyester binder in reducing or eliminating indentations of the buffer tubes. The binder is applied under tension to fully couple the buffer tubes together. The binder is therefore stretched when applied over the core. Indentations of the buffer tubes can occur during jacketing of the core with a molten polymer. A conventional polyester binder typically goes through a glass transition at approximately 110° C., with amorphous regions of the polyester undergoing a thermal transition from glassy to rubbery when the hot cable sheath is applied during manufacturing. The polyester polymer chains which were stretched in the glassy state can therefore relax when heated. This relaxation allows the binder to shorten, with the binder contracting towards the center of the cable, often resulting in undesirable indentation of the buffer tube.

Although polypropylene has a lower melting temperature than polyester, it is more resistant to shrinkage during jacketing. Polypropylene has a glass transition at approximately −4° C. and a melting temperature of 165° C., so a polypropylene binder does not undergo any significant thermal transition between room temperature and 165° C. Because the glass transition temperature of polypropylene is lower than ambient temperature, any orientation of the amorphous regions of the polypropylene binder can fully relax after the cable core is stranded. During jacketing, the polypropylene binder is heated close to its melting temperature when the cable sheath is applied, but is not heated enough to fully melt the crystalline regions of the binder. Even if the initial temperature of the cable sheath is above the melting temperature of the polypropylene binder, the crystalline regions of the binder does not fully melt as long as the binder is not exposed to the elevated temperature for a long enough time to fully melt the crystalline regions of the binder. It is impossible for the material to relax unless the polypropylene crystallites melt, and therefore, the resulting cable is substantially free from indentations.

Furthermore, the polypropylene binder may be modified such that an installer can remove the polypropylene binder easier than the conventional aramid or polyester yarn during cable installation. When the installer opens a conventional optical fiber cable having aramid or polyester yarns, he needs to remove the cable sheath and aramid or polyester yarns surrounding the cable core. However because those yearns are robust materials, the installer has to cut the aramid or polyester by knifes. Such process reduces cable installation efficiency, puts unnecessary burden on the installer and adds cost. However, appropriate property of the polypropylene binder 4 may be changed without affecting its melting temperature such that the installer can remove the polypropylene binder 4 from the cable core 3 just by hands without any tool. To enhance the accessibility to the cable core 3, a ripcord may be added between the cable core 3 and the binder 4 for easier removal of the binder 4 and the cable sheath 6.

Conventional aramid binder does not shrink and there is no thermal transition between room temperature and approximately 430° C. However, aramid binders are more expensive than polypropylene binders. Therefore, use of polypropylene binders in an optical fiber cable could bring a significant cost saving in cable manufacturing.

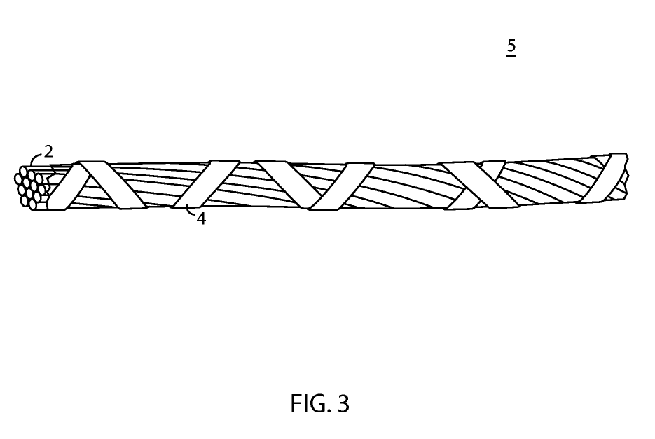

Before or during stranding process, the loose tubes 2 may be helically stranded before wrapped around by the binder 4 to form a bundle 5 as shown in FIG. 3. When the loose tubes 2 are stranded, for example, S-Z stranding or other suitable stranding methods may be used.

After the binder 4 grips loose tubes 2 together to form the bundle 5, the cable sheath 6 is applied to the bundle 5 to form the loose tube optical fiber cable 10. The cable sheath 6 can be made from various materials, but is typically made from a plastic, such as PVC. As an alternative to the PVC, the cable sheath 6 may be made from other plastics including fiber-reinforced polypropylene, a fluoro-plastic, such as PVDF, a fluoro-compound or other suitable polymeric blends. Preferably, with or without an optional ripcord, the materials for the cable sheath 6 and the binder 4 are selected such that an installer can open the optical fiber cable 10 and remove the binder 4 by installer's hands. Most preferably, the cable sheath 6 is made of polyethylene. The cable sheath 6 can also be designed to have increased flame resistance such that the optical fiber cable 10 may be rated as a riser, a plenum and/or a low smoke zero halogen. In addition, the cable sheath 6 can be designed to resist UV light, if so desired.

The present invention works well for various sizes of optical fiber cables. For example, the loose tube optical fiber cable according to the present invention may include six loose tubes having twelve optical fiber in each loose tube (i.e. 6×12 loose tube optical fiber cable), and the cable diameter may be less than 10 mm. Furthermore, because cables with relatively small loose tubes are more vulnerable to indentations, the present invention works exceptionally well for the loose tube optical fiber cables having the loose tube diameter of less than approximately 1.8 mm. In addition, the optical fiber cable may be an outside plant optical fiber cable having a water-blocking material surrounding the cable core. Alternatively or in combination, the polypropylene binder may be coated with superabsorbent material to create a waterswellable binder.

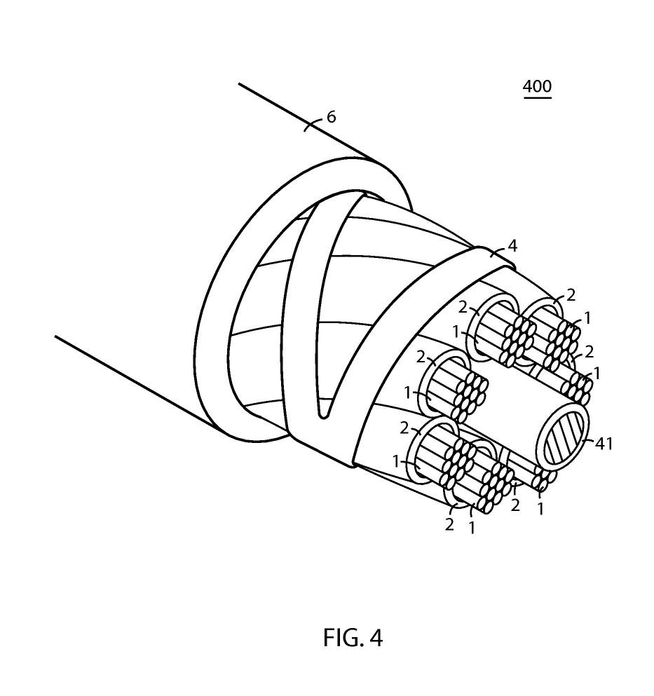

Also, a person skilled in the art can envision other embodiments of the present invention. For example, as shown in FIG. 4, the plurality of loose tubes 2 may stranded helically around a central strength element 41 to form a cable 400. Also, a cable may have multiple bundles inside the cable, and a second binder may grip those multiple bundles. Those bundles may be arranged to be helically stranded before wrapped around by the second binder.

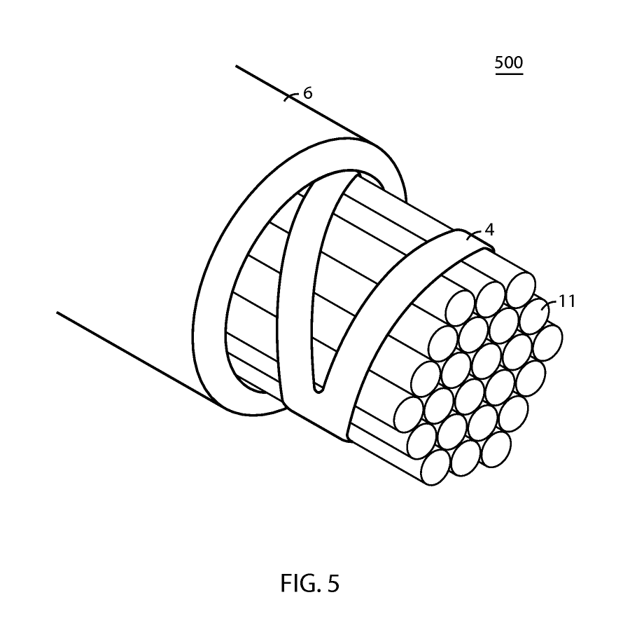

In addition, application of the polypropylene binder may equally work well for other types of cable structure. For example, the polypropylene binder 4 may be used in a buffered optical fiber cable 500 shown in FIG. 5. Because the polypropylene binder 4 does not cut into a plurality of the buffered optical fibers 11, indentations on the buffered optical fibers 11 can be substantially eliminated.

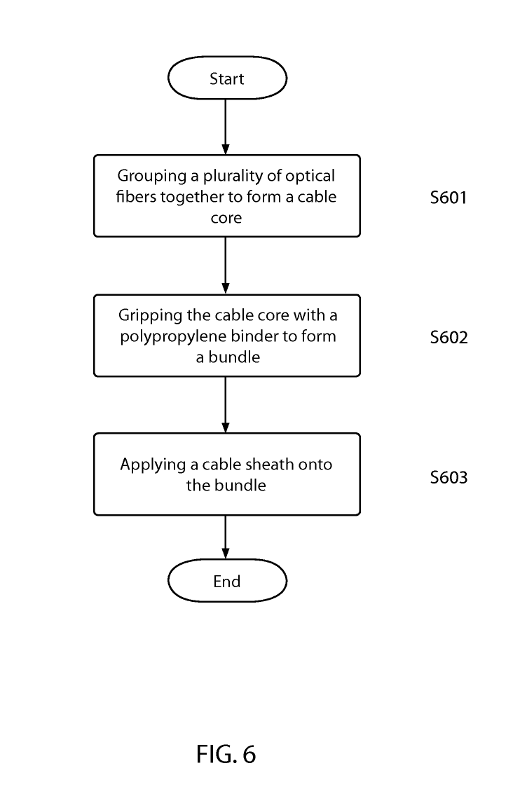

Referring now to FIG. 6, a flowchart of a method of making an optical fiber cable according to one aspect of the present invention is shown. The method comprises the following steps:
placing a plurality of optical fibers together to form a cable core (S601),
gripping the cable core with a polypropylene binder to form a bundle (S602), and
applying a cable sheath onto the bundle (S603).

In step S601, the optical fibers that form the cable core may be buffered optical fibers or the optical fibers may be contained in a plurality of loose tubes. If the plurality of the loose tubes contains the optical fibers, a standard process is used to place the optical fibers inside each loose tube. Depending on the application of the cable, numbers of the optical fibers, and/or types of the optical fibers in each loose tube may be different. Also the optical fibers may be colored to aid identification of the optical fibers in each loose tube, and may be stranded. Furthermore, the loose tubes may contain one or more fillers.

In step S602, the cable core is gripped by a polypropylene binder to form a bundle. In the case of loose tubes, the plurality of the loose tubes may be arranged to be helically stranded before wrapped around by the polypropylene binder. When the loose tubes are stranded, for example, S-Z stranding or other suitable stranding methods may be used. The polypropylene binder may be thread, yarn, a thin film or a tape. Binding force to create a bundle depends on the factors such as the width and thickness of the binder. Typically, a binding force of the binder is less than 1000 cN to prevent unintended breaks of the binder. Preferably, a binding force of the binder is less than 800 cN.

In step S603, a cable sheath is applied onto the bundle. When the cable sheath is applied onto the bundle, the cable sheath is extruded about the bundle at the melting temperature of the cable sheath material. Typical melting temperature of the cable sheath material is more than 120° C. Medium-density polyethylene and high-density polyethylene have a melting temperature of approximately 130 C, while nylon 12 has a melting temperature of approximately 180° C. Typically, the temperature of the cable sheath is in the range from 180-220° C. However, as long as the temperature of the polypropylene binder does not exceed its melting temperature or is not exposed to the elevated temperature for a long enough time for melting to occur when the cable sheath is applied, the polypropylene binder does not undergo any substantial thermal transition. Because no thermal transition occurred, the polypropylene binder does not relax, shrink and subsequently cut into the loose tubes or the buffered optical fibers to cause indentations. Therefore, the cable manufactured using the above mentioned method is substantially free from indentations.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An optical fiber cable comprising:
a cable core having a plurality of optical fibers;
a polypropylene binder gripping the cable core to form a bundle; and
a cable sheath surrounding the bundle,
whereby the optical fiber cable is substantially free from indentations.

2. The optical fiber cable according to claim 1, wherein the optical fibers are buffered optical fibers.

3. The optical fiber cable according to claim 1, wherein the plurality of the optical fibers are stored in a plurality of loose tubes to form the cable core.

4. The optical fiber cable according to claim 3, wherein the diameter of each loose tube is less than approximately 1.8 mm.

5. The optical fiber cable according to claim 3, wherein loose tubes are made of polypropylene.

6. The optical fiber cable according to claim 3, wherein the cable core further comprises a filler.

7. The optical fiber cable according to claim 3, wherein the optical fiber cable is a 6×12 loose tube optical fiber cable and the cable diameter is less than 10 mm.

8. The optical fiber cable according to claim 3, wherein the plurality of loose tubes are stranded helically around a central strength element.

9. The optical fiber cable according to claim 1, wherein the polypropylene binder is a thread, yarn, thin film or tape.

10. The optical fiber cable according to claim 1, wherein the cable sheath is made of polyethylene.

11. The optical fiber cable according to claim 1, wherein the optical fiber cable is an outside plant optical fiber cable and the cable core is surrounded by water-blocking material.

12. The optical fiber cable according to claim 1, wherein the polypropylene binder is coated with superabsorbent material.

13. The optical fiber cable according to claim 1, wherein the material for the polypropylene binder is selected such that an installer can remove the polypropylene binder by hand.

14. The optical fiber cable according to claim 1, wherein the cable is a micro duct cable having smooth and consistent outer surface, wherein the polypropylene binder is a wide tape and the thickness of the cable sheath is less than 0.8 mm.

15. A method of making an optical fiber cable comprising the steps of:
grouping a plurality of optical fibers together to form a cable core;
gripping the cable core with a polypropylene binder to form a bundle; and
applying a cable sheath onto the bundle,
whereby the optical fiber cable is substantially free from indentations.

16. The method of making an optical fiber cable according to claim 15, wherein the step of grouping a plurality of optical fibers to create a cable core further comprises a step of placing the plurality of the optical fibers inside a plurality of loose tubes, and a step of grouping the plurality of the loose tubes to form the cable core.

17. The method of making an optical fiber cable according to claim 15, wherein the step of grouping a plurality of optical fibers together to form a cable core further includes a step of inserting one or more fillers to the cable core.

18. The method of making an optical fiber cable according to claim 15, wherein the polypropylene binder does not undergo any substantial thermal transition when the cable sheath is applied to the bundle.

19. The method of making an optical fiber cable according to claim 15, wherein the crystalline regions of the polypropylene binder does not fully melt when the cable sheath is applied to the bundle.
